(19) United States
(12) Patent Application Publication
(10) Pub. No.: US 2012/0142534 A1
(43) Pub. Date: Jun. 7, 2012

(54) GRANULAR COMPOSITIONS

(76) Inventors: Mark Linden Dahmer, Centennial, CO (US); Jason Lee Alford, Oakland, TN (US)

(21) Appl. No.: 13/294,575

(22) Filed: Nov. 11, 2011

Related U.S. Application Data
(60) Provisional application No. 61/420,489, filed on Dec. 7, 2010.

(51) Int. Cl. A01N 27/00; A01N 25/26

(52) U.S. Cl. 504/357

(57) ABSTRACT

In a first aspect of the present invention, there is provided a method of improving the cultivation of rice in a paddy comprising adding a granular composition to the water in said paddy, wherein said granular composition comprises one or more cyclopropene compound encapsulated in a molecular encapsulation agent.

### BACKGROUND

It is sometimes desired to use a cyclopropene compound to enhance the growth of crop plants. US patent publication 2007/0165166 discloses methods involving contacting crop plants with compositions that contain a cyclopropene compound. In the examples of US 2007/0165166, that contacting is conducted by spraying a liquid composition onto the plants. There are drawbacks associated with using liquid compositions containing cyclopropene compound. Liquid compositions require special equipment, such as, for example, equipment for spraying, and such equipment is sometimes not available. Also, liquid compositions are usually stored in enclosed tanks or other enclosed containers. If the liquid composition contains a cyclopropene compound that is volatile, the headspace in the enclosed container could accumulate a high concentration of volatile organic compound, which could create a hazardous situation.

There are also drawbacks to applying gaseous compositions to crop plants in a field. When used in an open field, a gaseous composition will diffuse into the atmosphere and may have little or no effect on the rice plants.

Rice is the seed of the monocot plants of the genus Oryza. The term “rice” herein is used to mean either the rice seed that is harvested or the rice plant on which the seed grows or will grow. Two species that are cultivated are Oryza sativa L. and Oryza glaberrima Steud. Rice is an important crop plant. It is desired to provide a method of using cyclopropene compound that enhances the growth of rice plants while avoiding one or more of the drawbacks discussed above.

### STATEMENT OF THE INVENTION

In a first aspect of the present invention, there is provided a method of improving the cultivation of rice in a paddy comprising adding a granular composition to the water in said paddy, wherein said granular composition comprises one or more cyclopropene compound encapsulated in a molecular encapsulation agent.

### DETAILED DESCRIPTION

A solid particle is characterized by its particle diameter. If the particle is not spherical, its particle diameter is taken herein to be the diameter of a sphere that has the same volume as the particle.

The practice of the present invention involves the use of one or more cyclopropene compound. As used herein, a cyclopropene compound is any compound with the formula

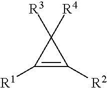

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and naphthyl) or aliphatic (including unsaturated aliphatic, partially saturated aliphatic, or saturated aliphatic); and they may be carbocyclic or heterocyclic (i.e., containing one or more heteroatom).

In preferred embodiments, one or more of R¹, R², R³, and R⁴ is hydrogen or (C₁-C₁₀) alkyl. More preferred are embodiments in which each of R¹, R², R³, and R⁴ is hydrogen or (C₁-C₈) alkyl. More preferred are embodiments in which, each of R¹, R², R³, and R⁴ is hydrogen or (C₁-C₄) alkyl. More preferred are embodiments in which each of R¹, R², R³, and R⁴ is hydrogen or methyl. More preferred are embodiments in which R¹ is (C₁-C₄) alkyl and each of R², R³, and R⁴ is hydrogen. Most preferred are embodiments in which R¹ is methyl and each of R², R³, and R⁴ is hydrogen, and the cyclopropene compound is known herein as “1-MCP.”

Preferred are embodiments in which a cyclopropene compound is used that has boiling point at one atmosphere pressure of 50° C. or lower; more preferred 25° C. or lower; more preferred 15° C. or lower. Independently, embodiments are preferred in which a cyclopropene compound is used that has boiling point at one atmosphere pressure of −100° C. or higher; more preferred −50° C. or higher; more preferred −25° C. or higher; more preferred 0° C. or higher.

The composition of the present invention includes at least one molecular encapsulating agent that encapsulates one or more cyclopropene compound or a portion of one or more cyclopropene compound. A complex that contains a cyclopropene compound molecule or a portion of a cyclopropene compound molecule encapsulated in a molecule of a molecular encapsulating agent is known herein as a “cyclopropene compound complex.”

In preferred embodiments, at least one cyclopropene compound complex is present that is an inclusion complex. In such an inclusion complex, the molecular encapsulating agent forms a cavity, and the cyclopropene compound or a portion of the cyclopropene compound is located within that cavity.

Preferably, in such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain for substantial amounts of time within the cavity of the molecular encapsulating agent.

The amount of molecular encapsulating agent can usefully be characterized by the ratio of moles of molecular encapsulating agent to moles of cyclopropene compound. In preferred embodiments, the ratio of moles of molecular encapsulating agent to moles of cyclopropene compound is 0.1 or larger; more preferably 0.2 or larger; more preferably 0.5 or larger; more preferably 0.9 or larger. Independently, in preferred embodiments, the ratio of moles of molecular encapsulating agent to moles of cyclopropene compound is 10 or lower; more preferably 5 or lower; more preferably 2 or lower; more preferably 1.5 or lower.

Suitable molecular encapsulating agents include, for example, organic and inorganic molecular encapsulating agents. Preferred are organic molecular encapsulating agents, which include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In preferred embodiments, the encapsulating agent is alpha-cyclodextrin, beta-cyclodextrin, gamma-cyclodextrin, or a mixture thereof. In more preferred embodiments of the invention, alpha-cyclodextrin is used.

The practice of the present invention involves the use of a granular composition. A granular composition is a composition that exists as solid particles under a pressure of 1 atmosphere and at all temperatures from 5° C. to 40° C. A granular composition is a collection of solid particles in which 90% or more of the weight of the collection resides in particles that have particle diameter of 1 micrometer or larger and in which 90% or more of the weight of the collection resides in particles that have particle diameter of 5 centimeter or smaller. Preferred are compositions in which 90% or more of the weight of the collection resides in particles that have particle diameter of 10 micrometer or larger. Also preferred are compositions in which 90% or more of the weight of the collection resides in particles that have particle diameter of 1 centimeter or smaller.

Preferred granular compositions contain 0.02% or more of cyclopropene compound, by weight based on the weight of the granular composition. More preferred granular compositions contain cyclopropene compound in the amount, by weight based on the weight of the granular composition, of 0.05% or more; more preferred is 0.09% or more. Preferred granular compositions contain 5% or less of cyclopropene compound, by weight based on the weight of the granular composition. More preferred granular compositions contain cyclopropene compound in the amount, by weight based on the weight of the granular composition, of 2% or less; more preferred is 1% or less; more preferred is 0.5% or less.

In addition to cyclopropene compound complex, the particles of the granular composition may contain any material (called “inert” material) that allows the particle to remain solid and that will not inhibit the function of the cyclopropene compound. Suitable materials for inclusion in the granular composition include, for example, sand (for example, feldspar sand), clay (for example, montmorillonite or attapulgite), coal dust, chipped brick, cellulosic fibers or other cellulosic materials, polymers, ground corn cobs, fertilizer, or mixtures thereof. Particles of the granular composition may optionally be coated, for example with polymer, graphite, wax, or a combination thereof.

Rice is often grown in a paddy. A paddy is a field that is flooded for some or all of the plant's growth cycle. Rice may be planted in the paddy prior to flooding the paddy, and in some of such cases the rice may grow to become seedlings before the paddy is flooded. Alternatively, the rice may be planted somewhere other than the paddy and then transplanted as seedlings into the paddy before the paddy is flooded. Often, after seedlings are established in the non-flooded paddy (either by growth from seeds or by transplantation), the paddy is then flooded. In many cases, the paddy remains flooded until shortly before harvest. Sometimes the paddy is drained for one or more short period during the growth cycle of the plants. When the paddy is flooded, the depth of the water is preferably between 20 mm and 100 mm. In preferred embodiments, the paddy is flooded for more than half of the time from transplantation of seedlings until harvest.

The rice that is used in the practice of the present invention may be any species of the genus Oryza. Preferred is Oryza sativa L.

In the practice of the present invention, granular composition is added to the water of the paddy one or more times during the growth cycle of the plants. The addition of the granular composition may be made during any time from transplantation of seedlings until harvest. The growth stages of rice may be described by reference to the BBCH scale for rice (published by the Federal Biological Research Centre for Agriculture and Forestry, Berlin and Braunschweig, Germany), which may be viewed, for example, at http://www.jki.bund.de/fileadmin/dam_uploads/_veroeff/bbch/BBCH-Skala_englisch.pdf. The BBCH scale provides a code number for each step in the growth cycle of rice, from code 00 (dry seed [caryopsis]) to 99 (harvested product).

It is preferred to treat the rice (i.e., to add the granular composition of the present invention to the water in the paddy) during one or more of the following growth stages: Panicle Development (BBCH codes 30-32); Boot (BBCH codes 40-45); Early Heading (BBCH codes 51-54); Post Anthesis (BBCH codes 65-70). More preferred is treatment during boot; more preferred is treatment during mid-boot (BBCH code 43).

It is preferred to treat rice that is exposed to high night time temperature. The treatment may take place before, during, or after the exposure to high night time temperatures. It is preferred to treat rice prior to exposure to high night time temperature. This can be accomplished by identifying rice that is expected to be exposed to high night time temperature, either because it is being grown in a location that often experiences high night time temperature or because of a specific local weather forecast.

High night temperature occurs during a night in which the lowest temperature during that night is 20° C. or higher. It is preferred to treat rice that experiences one or more night during which the lowest temperature is 20° C. or higher; more preferred is to treat rice that experiences one or more night during which the lowest temperature is 25° C. or higher; more preferred to treat rice that experiences one or more night during which the lowest temperature is 30° C. or higher.

One useful way to characterize the amount of cyclopropene compound that is used is to state the grams of cyclopropene compound (the active ingredient or “ai”) that is applied per unit of area. This amount is reported as grams of ai per hectare (ga/ha).

Preferred embodiments employ cyclopropene compound at a rate of 1 ga/ha or higher; more preferred is 2 ga/ha or higher; more preferred is 5 ga/ha or higher. Preferred embodiments employ cyclopropene compound at a rate of 100 ga/ha or lower; more preferred is 60 ga/ha or lower; more preferred is 40 ga/ha or lower.

Another characteristic of treatment methods is the “distribution fraction” of application of granules. Granules are considered to be distributed over the rice paddy randomly but consistently. That is, granules are considered to be distributed in a way that allows the randomness to be apparent if a small area (for example, 5 cm by 5 cm) is examined and that provides a consistent amount of cyclopropene compound to each large area (0.5 meter by 0.5 meter or larger). By “consistent amount” is meant that over the entire rice paddy, if each square sized 0.5 meter by 0.5 meter were examined and the amount of cyclopropene compound were measured, the standard deviation of the distribution of those amounts would be 20% or less of the mean amount.

“Distribution fraction” is characterized by reference to application of standard granules. As used herein, standard granules have 0.1% cyclopropene compound by weight based on the total weight of the granules. When standard granules are distributed randomly but consistently, the density is said to be 100%. To vary the density, a plot that is larger than 0.25 square meters may be divided into sub-plots that are each 0.5 meter by 0.5 meter. Standard granules may be spread randomly and consistently within some sub-plots, while no granules are spread in the other sub-plots. Then the entire plot is said to be spread at distribution fraction of D %, where D %=100*(number of sub-plots containing granules)/(total number of sub-plots). It is contemplated that varying the density could mimic the effect of using different-size granules or more concentrated granules.

Preferred are embodiments in which distribution fraction is 25% or higher; more preferred is 50% or higher; more preferred is 100% or higher.

### EXAMPLES

### Preparation of Granule Formulations

Unless explicitly stated otherwise herein below, granule formulations are described as follows.

Granule formulations were made by blending Complex Powder with a carrier. Complex Powder contained 1-methylcyclopropene (1-MCP) encapsulated in alpha-cyclodextrin, with concentration of 1-MCP of approximately 3.8% by weight, based on the weight of Complex Powder. Each granule formulation contained 0.1% by weight 1-MCP, based on the weight of said granule formulation.

In the granule formulations, 90% or more of the weight, based on the weight of the granule formulation, was particles with particle diameter of 0.1 mm or greater and 10 mm or smaller.

### Method of Treatment

Rice plants in paddies were treated by spreading granule formulation. Granules were scattered randomly and consistently, in a way that gave uniform distribution over the treated area, except as specifically stated below. Replicate plots were treated; the number of replicate plots is denoted “N” below. “Rate” of application of granules is reported as “ga/ha” which is grams of active ingredient (i.e., 1-MCP) per hectare. “nt” means not tested.

### Assessment of Improvement to Crop Yield

Each treated plot of rice paddy was compared to an appropriate untreated control plot. The outcome is reported as “DY %” (Delta Yield Percent), which is defined as follows:

DY%=100*[(Y_{T}−Y_{U}/Y_{U}]

where Y_{T}=yield of the treated plot, and
where Y_{U}=yield of the untreated plot.
For example, DY of 10% would mean the treated plot had yield that was 10% higher than the untreated plot. Negative Delta Yield means that the treated rice had lower yield than the untreated rice.

### Example 1

### Granule Formulation

Complex Powder was blended with dextrose to make a powder with 0.14% 1-MCP by weight based on the weight of the blend. That blend was mixed with a solution of dextrose in water (40% by weight of dextrose, based on the weight of the solution). The resulting mixture was extruded through a circular die and then dried in a fluid bed drier, to make cylinders of diameter approximately 1.5 mm and length of approximately 1 to 3 mm. The granule formulation had 0.1% 1-MCP by weight, based on the weight of the granule formulation.

### Examples 2-7

### Granule Formulations

Complex Powder was blended with various carriers as follows. All of the resulting granule formulations had 0.1% 1-MCP by weight, based on the weight of the granule formulation (except for Ex. 7 (i.e., Example 7), which had 0.2%).

| Example | |
|---|---|
| No. | Carrier |
| 2 | brick chips |
| 3 | cellulose fiber granules (Ecogranule ™ from |
| | Cycle Group, Inc.) |
| 4 | montmorillonite clay (median particle size approximately |
| | 2 mm) |
| 5 | montmorillonite clay (median particle size approximately |
| | 0.5 mm) |
| 6 | feldspar sand, coated with Complex Powder |
| 7 | feldspar sand, coated with Complex Powder (0.2% 1-MCP |
| | by weight, based on the weight of granule formulation) |
| 101 | Complex Powder, with dextrose carrier, in granule form. |
| 102 | Complex powder was added to paraffinic oil, to give a liquid |
| | with concentration of 1% 1-MCP by weight, based on the |
| | weight of the liquid, and the liquid was used to coat limestone |
| | granules to give concentration of 0.04% 1-MCP by weight, |
| | based on the weight of the coated limestone |
| 103 | A powder that was similar to Complex Powder but had 0.14% |
| | 1-MCP by weight based on the weight of the powder was |
| | mixed with clay to form granules. |

### Example 8

### Common Features

| Granule Formulation: | Timing: | Rate: | N |
|---|---|---|---|
| variable | variable | variable | variable |

Results:

| Formulation | | Rate | Average | |
|---|---|---|---|---|
| Example No. | Timing | (ga/ha) | Delta Yield | N |
| 1 | Panicle Initiation | 2.5 | 3.40% | 6 |
| 1 | Panicle Initiation | 5 | 3.01% | 6 |
| 1 | Panicle Initiation | 10 | 3.54% | 6 |
| 1 | Panicle Initiation | 20 | 7.15% | 6 |
| 1 | Panicle Initiation | 25 | 7.89% | 6 |
| 1 | Mid-Boot | 2.5 | 0.61% | 7 |
| 1 | Mid-Boot | 5 | 6.28% | 10 |
| 1 | Mid-Boot | 5 × 2 | 1.76% | 3 |
| 1 | Mid-Boot | 10 | 3.30% | 19 |
| 1 | Mid-Boot | 20 | 6.16% | 7 |
| 1 | Mid-Boot | 25 | 8.40% | 24 |
| 1 | Early Milk | 25 | 2.01% | 7 |
| 3 | Mid-Boot | 10 | 3.80% | 5 |
| 3 | Mid-Boot | 25 | 4.26% | 6 |
| 4 | Mid-Boot | 10 | 4.29% | 6 |
| 4 | Mid-Boot | 25 | 4.00% | 6 |
| 5 | Mid-Boot | 10 | 1.20% | 6 |
| 5 | Mid-Boot | 25 | 3.27% | 6 |
| 6 | Mid-Boot | 10 | 3.67% | 6 |
| 6 | Mid-Boot | 25 | 4.00% | 5 |
| 7 | Mid-Boot | 10 | 5.46% | 6 |
| 7 | Mid-Boot | 25 | 6.00% | 4 |

Note:
“5 × 2” means that 2 applications were made, each with 5 grams of active ingredient per hectare.

### Example 9

### Common Features

| Granule Formulation: | Timing: | Rate: | N |
|---|---|---|---|
| Example 1 | variable | 25 ga/ha | 21 |

Each treatment plot was surrounded by untreated control plots. Results were as follows:

| Timing | Delta Yield |
|---|---|
| mid booting | 10% |
| early heading | 5% |
| milky stage | 2% |

### Example 10

### Treatment of Rice Plants in Four Locations

Common Features:

| Granule Formulation: | Timing: | N | Rate: |
|---|---|---|---|
| variable | mid-boot | variable | variable |

Rice plants were treated in four locations, denoted L1, L2, L3, and L4. Rice variety TN11 was used in L1, L2, and L3, while rice variety Bao That was used in L4.
Results were as follows:

| | | L1 | | L2 | | L3 | | L4 | |
|---|---|---|---|---|---|---|---|---|---|
| Formu- | Rate | | Delta | | Delta | | Delta | | Delta |
| lation | ga/ha | N | Yield | N | Yield | N | Yield | N | Yield |
| none | 0 | 3 | 0% | 1 | 0 | 3 | 0 | 3 | 0 |
| Ex. 1 | 12 | 3 | 4% | 1 | 6% | 3 | −3.2% | 3 | nt |
| Ex. 1 | 25 | 3 | 1% | 1 | nt | 3 | nt | 3 | 12% |
| Ex. 6 | 10 | 3 | 5% | 1 | 2% | 3 | −4.3% | 3 | nt |
| Ex. 6 | 25 | 3 | 5% | 1 | nt | 3 | nt | 3 | 3% |
| Ex. 7 | 10 | 3 | 10% | 1 | 6% | 3 | 0.3% | 3 | nt |
| Ex. 7 | 25 | 3 | 6% | 1 | nt | 3 | nt | 3 | 1% |

In this study, the only Delta Yield value that is considered to have statistical significance is the result for L4, Ex. 1, at 25 ga/ha.

### Example 11

### Variation of Distribution Fraction

Common Features:

| Granule Formulation: | Timing: | N | Rate: |
|---|---|---|---|
| Ex. 1 | mid-boot | 2 | variable |

In order to test what the effect would be of treating with much larger particles, granules were distributed as follows. Each plot was divided into 100 equal sub-plots. The entire amount of granule formulation that would have been spread over the entire plot was instead spread only in a fraction of the subplots. Within each sub-plot, granules were spread randomly and consistently. The “distribution fraction” is the fraction of sub-plots that receive granules, compared to the total plot, expressed as a percentage. For example, when one plot was divided into 100 sub-plots, and granules were spread only in one fourth of those sub-plots, then the distribution fraction was 25%.

Results were as follows:

| Rate (g/ha) | Distribution Fraction | Delta Yield |
|---|---|---|
| 10 | 5% | 1.50% |
| 10 | 25% | 1.55% |
| 10 | 50% | 5.96% |
| 10 | 100% | 7.14% |
| 25 | 5% | −0.55% |
| 25 | 25% | 0.75% |
| 25 | 50% | 4.22% |
| 25 | 100% | 11.6% |

### Example 12

### Common Features

| Granule Formulation: | Timing: | N | Rate: |
|---|---|---|---|
| variable | mid-boot | 3 | variable |

This example compared treatments as follows:
“in water”: granules were spread over the canopy of leaves; some granules settled on leaves, others went directly into the water.
“directed between rows”: plants were bent aside and granules were spread directly on the water in between plants.
“foliar”: Complex Powder was spread over the canopy of leaves, while a plastic sheet was placed on the surface of the water to prevent powder from entering the water.

### Results:

| Rate (g/ha) | Material | Treatment | Delta Yield % |
|---|---|---|---|
| 5 | Ex. 1 | in-water | 8.12 |
| 5 | Ex. 1 | directed between rows | 5.56 |
| 5 | Complex Powder | foliar | 5.80 |
| 10 | Ex. 1 | in-water | 2.60 |
| 10 | Ex. 1 | directed between rows | 8.99 |
| 5 | Complex Powder | foliar | 4.93 |
| 25 | Ex. 1 | in-water | 5.82 |
| 25 | Ex. 1 | directed between rows | 14.51 |
| 5 | Complex Powder | foliar | 16.96 |

### Examples 13 and 14

### Common Features

| Granule | | | |
|---|---|---|---|
| Formulation: | Timing: | N | Rate: |
| variable | 168 days after | variable | 10 ga/ha |
| | planting | | |

Tests were made in three different locations: L131, L132, and L133. Results:

| Example 13 | | Example 14 |
|---|---|---|
| L131 | L132 | L133 |

| Granule | | Delta | | Delta | | Delta |
|---|---|---|---|---|---|---|
| Formulation | N | Yield | N | Yield | N | Yield |
| Ex. 101 | 6 | 6.1% | 6 | 7.1% | 5 | 11.1% |
| Ex. 102 | 6 | 5.2% | 6 | 8.5% | 5 | 9.9% |

### Example 15

### Common Features

| Granule Formulation: | Timing: | N | Rate: |
|---|---|---|---|
| Ex. 1 | mid-boot | 6 | variable |

Plots were treated one time at mid-boot, except for the sample marked “2×5,” which was treated 5 times at 2 ga/ha each, at mid-boot and then 4 more times at 2-day intervals. Results:

| Rate | Delta Yield |
|---|---|
| 5 ga/ha | 3.2% |
| 10 ga/ha | 7.3% |
| 2X5 | 2.8% |

### Example 16

### Common Features

| Granule Formulation: | Timing: | N | Rate: |
|---|---|---|---|
| Ex. 1 | mid-boot | 6 | variable |

Plots were treated with varying distribution fraction as defined in Example 11.

### Results:

| Rate | Distribution Fraction | Delta Yield |
|---|---|---|
| 10 ga/ha | 5% | 2.6% |
| 25 ga/ha | 5% | 4.0% |
| 10 ga/ha | 25% | 0.3% |
| 25 ga/ha | 25% | 4.0% |
| 10 ga/ha | 50% | 3.4% |
| 25 ga/ha | 50% | 4.5% |
| 10 ga/ha | 100% | 6.3% |
| 25 ga/ha | 100% | 13.4% |

### Example 17

### Common Features

| Granule Formulation: | Timing: | N | Rate: |
|---|---|---|---|
| Ex. 6 | mid-boot | 4 | variable |

### Results:

| Rate | Rice Variety | Delta Yield |
|---|---|---|
| 10 ga/ha | TN11 | 3.66% |
| 25 ga/ha | TN11 | 6.84% |
| 10 ga/ha | TG9 | 0.79% |
| 25 ga/ha | TG9 | 13.13% |

### Example 18

### Common Features

| Granule | | | | Rice |
|---|---|---|---|---|
| Formulation: | Timing: | N | Rate: | Variety |
| Ex. 1 and Ex. 6 | mid-boot | 1 | 10 ga/ha and | MR219 |
| | | | 25 ga/ha | |

Some plots were treated with Ex. 1, while others were treated with Ex. 7. The yield of each plot was compared to an appropriate untreated control plot, and the results were averaged together:

| Rate | Delta Yield |
|---|---|
| 10 ga/ha | 4.9% |
| 25 ga/ha | 0.6% |

We claim:

1. A method of improving the cultivation of rice in a paddy comprising adding a granular composition to the water in said paddy, wherein said granular composition comprises one or more cyclopropene compound encapsulated in a molecular encapsulation agent.

2. The method of claim 1, wherein the amount of said cyclopropene compound is 8 mg per hectare or greater.

3. The method of claim 1, wherein said adding said granular composition to said water meets one or both of the following criteria:
(a) said adding said granular composition to said water is performed after said rice has been exposed to one or more night during which the lowest temperature during that night was 20° C. or higher; or
(b) said adding said granular composition to said water is performed at a time when said rice is expected to be exposed in the future to one or more night during which the lowest temperature during that night will be 20° C. or higher.
